(19) United States
(12) Patent Application Publication
(10) Pub. No.: US 2016/0260089 A1
(43) Pub. Date: Sep. 8, 2016

(54) SECURE ACCOUNT MANAGEMENT USING TOKENS

(71) Applicant: Shanghai Luluyou Information Technology Ltd., Shanghai (CN)

(72) Inventor: Rong Chen, Shanghai (CN)

(21) Appl. No.: 14/798,290

(22) Filed: Jul. 13, 2015

(30) Foreign Application Priority Data
Mar. 2, 2015 (CN) 201510093393.X

(51) Int. Cl. G06Q 20/36; G06Q 20/38; G06Q 20/40; H04L 9/32

(52) U.S. Cl. CPC G06Q 20/367; H04L 9/3247; H04L 9/3236; G06Q 20/3825; G06Q 20/3827; G06Q 20/405; G06Q 2220/00

(57) ABSTRACT

Managing a user account includes: accessing the user account having a stored value, wherein the stored value is tokenized into a plurality of tokens corresponding to a set of available token units, and at least one of the plurality of tokens has a corresponding identifier; and in response to an account output request that includes a requested amount to be output: determining an output unit combination comprising a set of one or more tokens that has a sum that meets or exceeds the requested amount; determining whether a set of one or more output constraints is met; and in response to the determination that the set of one or more output constraints is met: outputting the set of one or more tokens associated with the output unit combination; and updating status information associated with the user account.

### CROSS REFERENCE TO OTHER APPLICATIONS

This application claims priority to People's Republic of China Patent Application No. 201510093393.X entitled METHOD AND APPARATUS FOR PROCESSING ELECTRONIC CURRENCIES, filed Mar. 2, 2015 which is incorporated herein by reference for all purposes.

### TECHNICAL FIELD

The present application relates to Internet technology. In particular, the present application relates to secure management of user accounts using tokens.

### BACKGROUND OF THE INVENTION

Electronic payment systems have seen explosive growth in recent years. Many systems offer users the convenience of using stored assets such as electronic currency, loyalty/rewards points, electronic credits, electronic vouchers, etc. to conduct transactions on e-commerce platforms. Due to the open nature of the Internet, payment systems are vulnerable to hacking, where criminals gain unlawful access to users' accounts and steal valuable assets from the users' accounts. For example, hackers can obtain usernames and passwords by phishing, installing malware on users' computers, breaching databases storing login information, etc., and then break into the users' account to make illegal transfers.

It can be difficult to verify the legitimacy of transactions, especially on platforms where a large number of transactions occur on a regular basis. Thus, measures are needed to improve the security of user accounts and prevent illegal transactions from taking place. Further, any security measure should minimally impede the normal operations of user accounts and should not consume excess amounts of computing resources.

### BRIEF DESCRIPTION OF THE DRAWINGS

Various embodiments of the invention are disclosed in the following detailed description and the accompanying drawings.

FIG. 1 is a functional diagram illustrating a programmed computer system for managing user accounts using tokens and token identifiers in accordance with some embodiments.

FIG. 2 is a system diagram illustrating an embodiment of a system for secure transactions using tokenized stored values.

FIG. 3 is a flowchart illustrating an embodiment of a process for handling a transaction.

FIG. 4 is a flowchart illustrating an embodiment of a process for establishing and/or maintaining a user account.

FIG. 5 is a block diagram illustrating an embodiment of a system configured to manage user accounts using tokens and token identifiers.

FIG. 6 is a block diagram illustrating another embodiment of a system configured to manage user accounts using tokens and token identifiers.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Managing user accounts is disclosed. In some embodiments, a stored value in a user account is tokenized into a plurality of tokens, and at least one of these tokens has a corresponding identifier. In response to an account output request, an output unit combination comprising a set of one or more tokens that has a sum that meets or exceeds a requested amount is determined. Further, whether a set of one or more output constraints is met is determined, and in response to a determination that the set of one or more output constraints is met, the status information associated with the user account is updated. The set of one or more tokens associated with the output unit combination is output. In some embodiments, circulation information of a token that has an identifier is updated and checked against an output constraint.

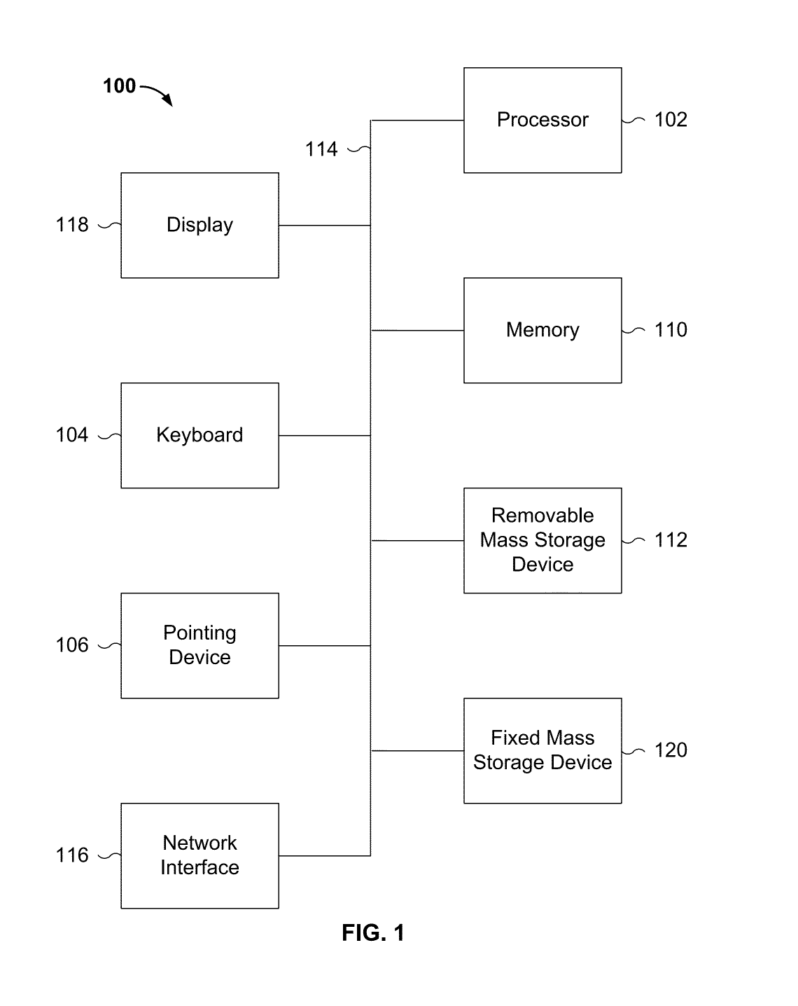

FIG. 1 is a functional diagram illustrating a programmed computer system for managing user accounts using tokens and token identifiers in accordance with some embodiments. As will be apparent, other computer system architectures and configurations can be used to perform token-based account management. Computer system 100, which includes various subsystems as described below, includes at least one microprocessor subsystem (also referred to as a processor or a central processing unit (CPU)) 102. For example, processor 102 can be implemented by a single-chip processor or by multiple processors. In some embodiments, processor 102 is a general purpose digital processor that controls the operation of the computer system 100. Using instructions retrieved from memory 110, the processor 102 controls the reception and manipulation of input data, and the output and display of data on output devices (e.g., display 118). In some embodiments, processor 102 executes/performs processes 300 and 400 described below.

Processor 102 is coupled bi-directionally with memory 110, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 102. Also as is well known in the art, primary storage typically includes basic operating instructions, program code, data, and objects used by the processor 102 to perform its functions (e.g., programmed instructions). For example, memory 110 can include any suitable computer-readable storage media, described below, depending on whether, for example, data access needs to be bi-directional or uni-directional. For example, processor 102 can also directly and very rapidly retrieve and store frequently needed data in a cache memory (not shown).

A removable mass storage device 112 provides additional data storage capacity for the computer system 100, and is coupled either bi-directionally (read/write) or uni-directionally (read only) to processor 102. For example, storage 112 can also include computer-readable media such as magnetic tape, flash memory, PC-CARDS, portable mass storage devices, holographic storage devices, and other storage devices. A fixed mass storage 120 can also, for example, provide additional data storage capacity. The most common example of mass storage 120 is a hard disk drive. Mass storages 112, 120 generally store additional programming instructions, data, and the like that typically are not in active use by the processor 102. It will be appreciated that the information retained within mass storages 112 and 120 can be incorporated, if needed, in standard fashion as part of memory 110 (e.g., RAM) as virtual memory.

In addition to providing processor 102 access to storage subsystems, bus 114 can also be used to provide access to other subsystems and devices. As shown, these can include a display monitor 118, a network interface 116, a keyboard 104, and a pointing device 106, as well as an auxiliary input/output device interface, a sound card, speakers, and other subsystems as needed. For example, the pointing device 106 can be a mouse, stylus, track ball, or tablet, and is useful for interacting with a graphical user interface.

The network interface 116 allows processor 102 to be coupled to another computer, computer network, or telecommunications network using a network connection as shown. For example, through the network interface 116, the processor 102 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 102 can be used to connect the computer system 100 to an external network and transfer data according to standard protocols. For example, various process embodiments disclosed herein can be executed on processor 102, or can be performed across a network such as the Internet, intranet networks, or local area networks, in conjunction with a remote processor that shares a portion of the processing. Additional mass storage devices (not shown) can also be connected to processor 102 through network interface 116.

An auxiliary I/O device interface (not shown) can be used in conjunction with computer system 100. The auxiliary I/O device interface can include general and customized interfaces that allow the processor 102 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; digital video disks (DVD), magneto-optical media such as optical disks; and specially configured hardware devices such as application-specific integrated circuits (ASICs), programmable logic devices (PLDs), phase change memory (PRAM), static random access memory (SDRAM), dynamic random access memory (DRAM), and ROM and RAM devices. Examples of program code include both machine code, as produced, for example, by a compiler, or files containing higher level code (e.g., script) that can be executed using an interpreter.

The computer system shown in FIG. 1 is but an example of a computer system suitable for use with the various embodiments disclosed herein. Other computer systems suitable for such use can include additional or fewer subsystems. In addition, bus 114 is illustrative of any interconnection scheme serving to link the subsystems. Other computer architectures having different configurations of subsystems can also be utilized.

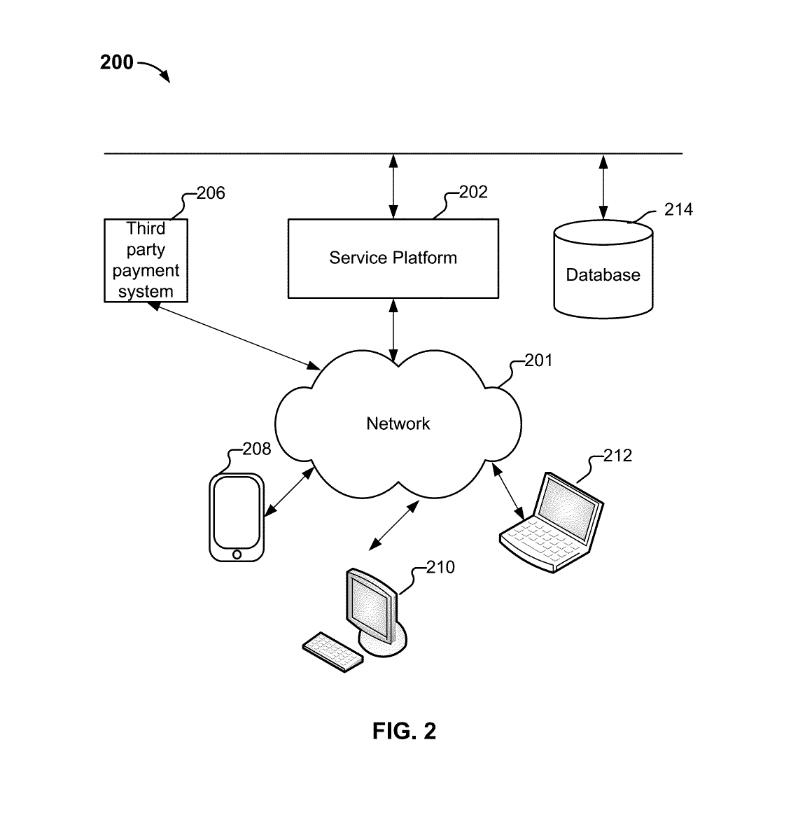

FIG. 2 is a system diagram illustrating an embodiment of a system for secure transactions using tokenized stored values. In some embodiments, service platform 202 of system 200 comprises one or more servers configured to perform functions including maintaining user accounts, which store valuable assets owned by users; exchanging data with client devices operated by the user; facilitating secure transactions between user accounts within the service platform; and optionally facilitating secure transactions between user accounts on the service platform with a third-party payment system such as 206. In some embodiments, the one or more servers are implemented on a distributed platform and/or a cloud-based computing platform utilizing virtual machines. Service platform 202 further includes one or more databases 214 configured to store user account information (e.g., the stored value associated with the user account, tokens and token identifiers, historical log information associated with the user's activities such as transferring of tokens in and out of the account, etc.). The one or more databases can be implemented on the one or more servers or on separate components or systems.

As will be described in greater detail below, the stored asset associated with a user's account is tokenized into a plurality of token units, and one or more of the token units have one or more corresponding identifiers. To perform a transaction on service platform 202, a user uses a browser or other appropriate application installed on a client device (e.g., 208-212) to access service platform 202, and specifies a payment amount and an account on the service platform to receive the payment. The client device can be a laptop computer, a desktop computer, a tablet, a mobile device, a smart phone, a wearable networking device, or any other appropriate computing device. In some embodiments, a web browser and/or a standalone application is installed at each client, enabling a user to access the service platform via a network such as 201. The network includes but is not limited to the Internet, a wide area network (WAN), a metropolitan area network (MAN), a local area network (LAN), a virtual private network (VPN), a wireless network, a wireline-based network, an Ad Hoc network, etc., or combinations thereof. A payment request is sent from the client device to the service platform. As will be described in greater detail below, upon receiving the payment request, service platform 202 establishes an output unit combination, determines whether the output unit combination meets one or more output constraints, and updates the relevant user account(s) in the event that the one or more output constraints are met.

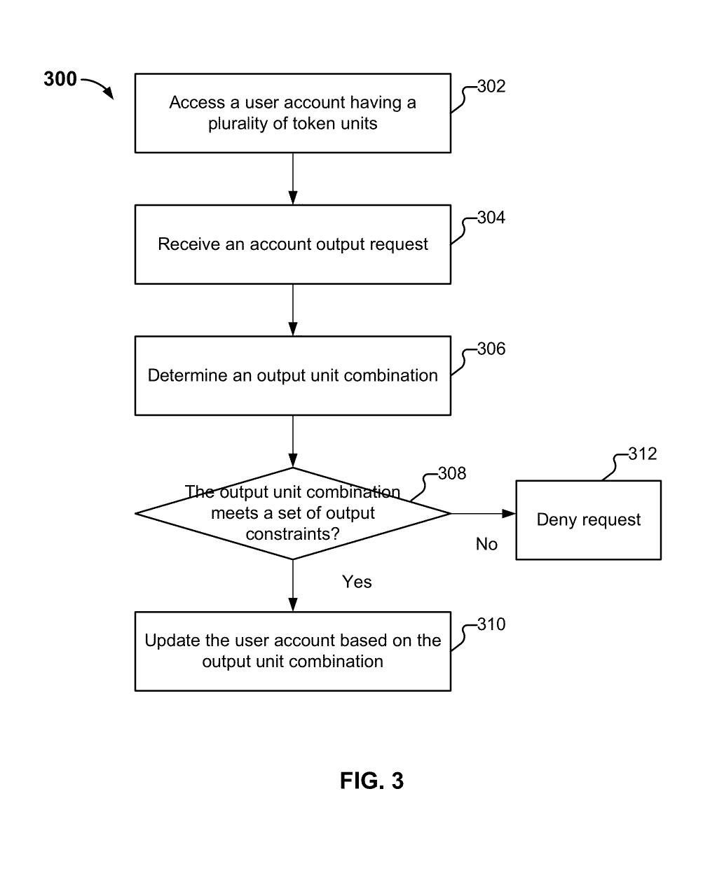

FIG. 3 is a flowchart illustrating an embodiment of a process for handling a transaction. Process 300 can be performed by a service platform 202 using a system such as 100.

At 302, a user account is accessed. In this example, the user account stores information pertaining to a certain valuable asset that has a stored value. In some embodiments, the user account information can be stored in a table or a database such as 214 that is indexed using user identifiers. To access the user account, the user identifier is looked up in the storage. Examples of a valuable asset include an electronic currency used to make payments, prepaid cards, credit cards, E-checks, E-wallets, virtual currency such as Q coins, Baidu coins, credits, vouchers, gift cards, discount coupons, rewards/royalty points, etc.

As will be described in greater detail below, the stored value for the asset stored in the user's account is tokenized into a plurality of tokens according to a set of token units. A token unit refers to a specific amount of value that is transferred/circulated during transaction such as making online payments between accounts. In some embodiments, a token unit corresponds to a currency unit which has certain denominations. Using the Chinese banknotes and coins for China's RMB as an example, for the currency unit of Yuan, the corresponding denominations are 1 Yuan, 2 Yuan, 5 Yuan, 10 Yuan, 50 Yuan, and 100 Yuan. For the currency unit of Jiao (10 cents), the corresponding denominations are 1 Jiao, 2 Jiao, and 5 Jiao. For the currency unit of Fen (1 cent), the corresponding denominations are 1 Fen, 2 Fen, and 5 Fen. In various embodiments, the token units and denominations available are preconfigured on the service platform. For example, before issuing an electronic currency, the issuing party (e.g., the company operating the service platform) can specify the corresponding set of token units associated with the electronic currency, and the denominations associated with each token unit. The token units being configured depend on implementation and do not need to adhere to the currency units used in actual currency (that is, the token units do not have to match the actual currency units and denominations of a country's banknotes or coins). For example, the issuing party may specify a set of token units that corresponds to 1000 Yuan (in the denomination of 1000 Yuan), 100 Yuan (in the denomination of 100 Yuan), 1 Yuan (in the denomination of 1 Yuan), etc. The token units and denominations described here are for purposes of illustration only, and many other combinations of token units are possible. In addition, the token units can correspond to currencies other than RMB, such as Euro, Dollar, points, etc.

At 304, an account output request is received. In this example, the account output request includes a request to transfer a requested amount from this user account (also referred to as the source user account or the sender account) to another user account (also referred to as the target user account or the receiver account) or to a separate payment system (e.g., a payment system operated by a third party such as a bank on which a receiving user has an account). The account output request can be initiated using a browser or an application executing on a device such as 208-212. The browser or the application provides user interfaces and associated operations. In some embodiments, the account output request can be specified as a message according to a predefined message and sent via an appropriate communication protocol. For example, the request can be specified as an extensible markup language (XML) document sent from the browser or an application using HTTPS or other appropriate communication protocol. In some embodiments, the output request can be sent using an application programming interface (API) (e.g., a function or procedure implemented using a remote procedure call, a socket call, etc.) that is supported by the service platform. Other appropriate forms can be used.

At 306, in response to receiving the account output request, an output unit combination is determined. In this example, the output unit combination includes one or more token units and is determined based on the amount requested by the account output request and the account status information. The denominations sum (i.e., the total amount) of the token units in the output unit combination meets or exceeds the requested amount. Details of how to determine the output unit combination are described below.

At 308, it is determined whether the output unit combination meets a set of one or more output constraints. Details of the constraints and their determination are described below.

If the set of one or more constraints is met, at 310, the user account is updated according to the output unit combination. As will be described in greater detail below, in some embodiments, the token units in the token unit combination are removed from the source user's account and added to the destination user's account. A token exchange process is optionally performed. A circulation counter associated with the tokens removed from the source user's account is updated.

If, however, the set of one or more constraints is not met, at 312, the request is denied. In some embodiments, the denial of the request is recorded in the log file or database, and an alarm and/or a message (e.g., an SMS message, an email message, etc.) is generated and sent to the source user and/or a system administrator.

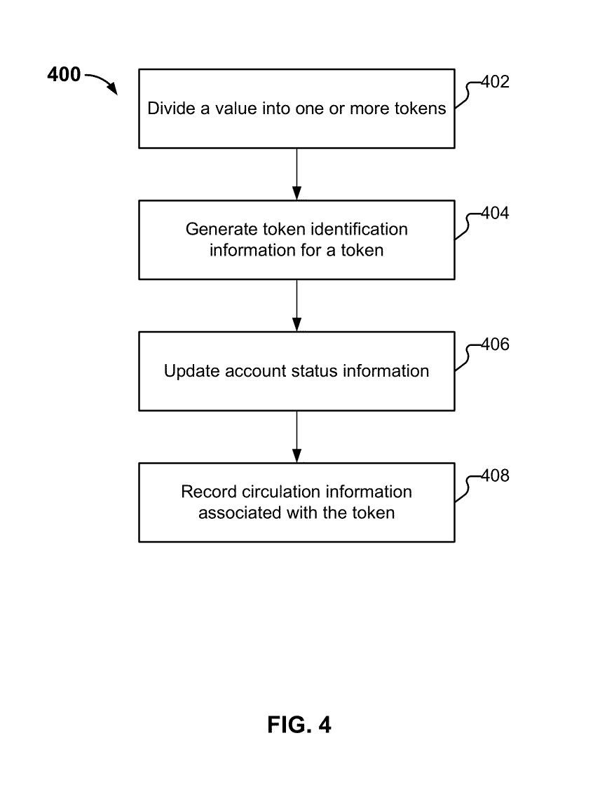

FIG. 4 is a flowchart illustrating an embodiment of a process for establishing and/or maintaining a user account. Process 400 can be performed prior to process 300 to set up the user's account.

At 402, a value (such as the stored value in the user's account, an amount that is to be transferred from a third-party payment gateway, etc.) is tokenized (divided) into one or more tokens based at least in part on the set of token units available to the user account.

In practice, there are often many ways to tokenize a value. For example, a stored value of 150 Yuan can be tokenized into a set of tokens comprising one 100 Yuan token and five 10 Yuan tokens, a set of tokens comprising fifteen 10 Yuan tokens, etc. In some embodiments, to facilitate the tokenization process, a set of one or more tokenization rules specifying how to tokenize the stored value is selected and applied to perform the tokenization. For example, a set of rules may specify the token units that are employed (e.g., token units of 10,000, 1,000, 100, 10, and 1 are available on the service platform, but the rule specifies that for accounts with stored values less than 20,000, the token units employed are 1,000, 100, 10, and 1). It may also specify that any token generated must be integer multiples of a token unit (thus, 50 Yuan will be expressed as 5x10 rather than 0.5x100). It may also specify the minimum token unit that is used (e.g., the minimum token unit used is 1). In some embodiments, the set of rules specifies that the stored value is to be divided to obtain the fewest number of tokens possible. In some embodiments, the set of rules specifies the token units selected according to the account history associated with the user's account. For example, if according to account history information the user has only used token units greater than or equal to 100, then the set of rules that is selected will specify that only token units greater than or equal to 100 be used to tokenize the value stored in this user's account. The example token units and/or rules described herein are for purposes of illustration only, and many other types of token units and/or rules can be configured and selected in various embodiments. In some embodiments, a set of one or more default rules is used, thus the selection of the rules is not required.

For instance, suppose user A's account has a stored value of sum−A. Further suppose that there are 3 possible grades of token units, expressed as α, β, γ, respectively, where a is the biggest grade (e.g., 1), β is one tenth of a (e.g., 0.1), and γ is one hundredth of α (e.g., 0.01). The stored value of user A's account is tokenized into one or more tokens according to a set of rules specifying that all three grades of token units are available, and the fewest tokens are to be generated. Thus, sum−A is divided as follows:

sum−A=a1×α+a2×β+a3×γ, wherein each of a1,a2,a3 is a positive integer.

As used herein, a1×α, a2×β, and a3×γ are referred to as the token values of tokens. In other words, sum−A is divided into three tokens having token values of a1×α, a2×β, and a3×γ, corresponding to token units of α, β, and γ, respectively. Depending on implementation requirements of the service platform, a token value (e.g., a1×α of 200x1) can be expressed and/or stored as a number (e.g., 200), a string (“200” or “200x1”), multiple numbers (e.g., a1=200 and 1), multiple strings (“200” and “1”), or any other appropriate format.

In another example, suppose that the set of rules specifies that only token units α and β are used, then the stored value sum−A is divided as follows:

sum−A=a1×α+a2×β+a3×γ=a1×α+a2×β+a3×0.1β=a1×α+(a2+0.1a3)β

The resulting set of tokens includes two tokens having token values of a1×α and (a2+0.1a3)×β, corresponding to token units of α, β, respectively.

At 404, a corresponding set of one or more token identifiers (also referred to as unit identification information) is generated for the set of one or more tokens. In some embodiments, the token identifiers are generated as serial numbers. In some embodiments, the token identifiers are generated as digital signatures using a digital signature generation process (also referred to as an encoding process) to ensure the integrity of information transmission and identity authentication of the senders. In some embodiments, the digital signature generation process is implemented using a cryptographic hash function such as MD4, MD5, MD6, SHA-1, SHA-2, SHA-3, RIPEMD-128, RIPEMD-160, etc. Many digital signature generation functions (e.g., cryptographic hash functions) can be used. The selection of the specific function is implementation dependent. For example, the memory requirement (e.g., size of the signature that is generated), the computation resources requirement (e.g., the amount of time or computation cycles required to perform the function), and/or the strength of encryption are some of the factors considered when selecting a specific function. In some embodiments, a cryptographic hash function is selected to ensure that for different input combinations, the identifiers generated are practically unique.

In various embodiments, the input to the digital signature generation includes the token value associated with a token, as well as any other parameters required according to the cryptographic function employed, such as output size, internal state size, etc. An input parameter can be expressed numerically (e.g., 100) or as a character string (e.g., “100x1”). In some embodiments, to ensure that different tokens having the same value receive different token identifiers, the input to the digital signature generation function further includes: the user's identification (ID) information, timestamp information (e.g., the time at which a token is generated), and/or other data used to randomize the output. For example, suppose the token value is 100x1, and the user ID is “A,” in some embodiments, the input to a cryptographic hash function can be a string “100x1A,” a string “A100x1,” a value that is computed by adding the Unicode values of “100x1” and “A,” etc. In some embodiments, timestamp information of “2015/01/01 01:02:03” is also added, and the input to the cryptographic hash function can be a string “100x1A2015/01/01 01:02:03,” “2015/01/01 01:02:03100x1A,” etc. Many input parameters and input formats can be used in various embodiments.

For example, suppose that user A's stored value is tokenized according to sum−A=a1×α+a2×β+a3×γ, yielding three tokens with token values of a1×α, a2×β, and a3×γ. For purposes of discussion, the token values (as well as any other required parameters such as user identifier) are input to a cryptographic hash function, and the token identifiers generated are denoted as identify-α-a1, identify-β-a2, and identify-γ-a3.

In some embodiments, to reduce the amount of computation resources required, token identifiers are generated only for tokens associated with token units of higher values and not generated for tokens associated with token units of lower values. For example, in some embodiments, only tokens associated with token units α or β are encoded to obtain token identifiers, while tokens associated with token unit γ is not encoded with token identifiers.

At 406, user account status information is updated. In some embodiments, the user account status information is stored in a database such as 214, and comprises token identifiers, token values, and the mappings of token identifiers and their respective token values. Table 1 is an example of at least a portion of user A's account status information, and Table 2 is an example of at least a portion of user B's account status information. In some embodiments, the tables include additional entries associated with the tokens, such as the time at which a token is received in the user's account (e.g., from the service platform directly when the user charges the account, from another user's account as a result of a successful transaction, etc.)

TABLE 1
User A's account

| Token ID | Token value |
|---|---|
| identify-α-a₁ | a₁ × α = 100 × 1 |
| identify-β-a₂ | a₂ × β = 9 × 0.1 |
| identify-γ-a₃ | a₃ × γ = 4 × 0.01 |

TABLE 2
User B's account

| Token ID | Token value |
|---|---|
| identify-α-b₁ | b₁ × α = 200 × 1 |
| identify-β-b₂ | b₂ × β = 3 × 0.1 |
| identify-γ-b₃ | b₃ × γ = 5 × 0.01 |

In some embodiments, to securely process the transactions and prevent fraud, circulation information associated with one or more tokens is recorded, at 408. In various embodiments, the circulation information can include a circulation count record of how many times a particular token (identified using its token identifier) has been circulated, a circulation frequency record of how many times in a specified time period a particular token has been circulated, or other appropriate circulation data associated with the tokens. The circulation information associated with a token can be stored in a database such as 214 associated with the service platform, and can be looked up using the token identifier as the index. In some embodiments, the time of the transaction is also optionally recorded. In some embodiments, the circulation information is reset periodically (e.g., a circulation count or a circulation frequency is reset to 0 every 24 hours). When the user's account is set up with a certain amount of stored value (e.g., when the user charges the account by transferring money from a third-party institution, when the user is given a certain amount of credit by the service platform, etc.), the tokens associated with the stored value are initialized with an initial circulation count number (e.g., 0 or 1 depending on implementation). Table 3 is an example showing the circulation information associated with tokens stored in users A and B's accounts when the accounts are initially configured. In this example, the number of times a token is circulated is set to 1 initially. In some embodiments, the record optionally includes additional entries (not shown) recording the source and target accounts for each time the token is transferred as well as the time of the transfers (e.g., from the source account of user A to the target account of user B at 2015/01/10 11:05:05, and from the source account of user B to the target account of user C at 2015/01/15 09:15:06, etc.), etc.

TABLE 3

| Token ID | Number of times circulated |
|---|---|
| identify-α-a₁ | 1 |
| identify-β-a₂ | 1 |
| identify-γ-a₃ | 1 |
| identify-α-b₁ | 1 |
| identify-β-b₂ | 1 |
| identify-γ-b₃ | 1 |

In some embodiments, an account update request is received where a first user transfers a certain amount of asset from a third party payment gateway (e.g., a bank account operated by a third party) into a second user's account on the service platform. Upon receiving the asset from the third-party gateway, the service platform tokenizes the requested amount into one or more tokens, generates token identification information for the one or more tokens, updates account status information for the second user's account, and records circulation information associated with the token according to a process similar to 400.

For example, user C attempts to transfer an amount of asset that is (c₁×β+c₂×γ) from a third-party payment gateway into user A's account by invoking an API provided by the service platform. This amount is tokenized into two tokens with the values of c₁×β and c₂×γ, respectively. Token identifiers of identify-β-c₁ and identify-β-c₂ are generated using a cryptographic hash function. These token identifiers are added to user A's account, and the account status information is updated as follows:

TABLE 4
User A's account

| Token ID | Token value |
|---|---|
| identify-α-a₁ | a₁ × α = 100 × 1 |
| identify-β-a₂ | a₂ × β = 9 × 0.1 |
| identify-γ-a₃ | a₃ × γ = 4 × 0.01 |
| identify-β-c₁ | c₁ × β = 3 × 0.1 |
| identify-γ-c₂ | c₂ × γ = 29 × 0.01 |

In some cases, the account update request includes a request to transfer a portion of the stored value to another account on the service platform. In some embodiments, the request is allowed to proceed only if the stored value in the source account exceeds or meets the amount that is requested to be transferred.

Referring to 306 of process 300, if the request is allowed to proceed, an output unit combination is determined. The output unit combination includes a set of one or more tokens in the user's account that has a total sum of token values equal to or greater than the amount requested.

For example, suppose user A makes a request for a payment to user B in the amount of m×β+n×γ, then the output unit combination can have a sum of token values that is equal to or greater than m×β+n×γ.

For instance, if in user A's account, a₂×β+a₃×γ is equal to or greater than m×β+n×γ, then the output unit combination includes tokens a₂×β (token ID=identify-β-a₂) and a₃×γ (token ID=identify-γ-a₃). Alternatively, a₁×α+a₃×γ, a₁×α+a₂×β, (0.1m+0.01n)×α, (a₁+0.1a₂+0.01a₃)×α, or other combinations can be used as the output unit combination, so long as the total value of the combination is equal to or greater than m×β+n×γ.

Referring to 308 of process 300, it is determined whether the output unit combination meets a set of one or more output constraints. The checking of the constraints prevents unauthorized transactions from taking place. Many output constraints are possible, and some examples are discussed below.

In some embodiments, an output constraint includes a circulation information-based constraint that requires the circulation information associated with the token units in the output unit combination to at least meet a threshold. In some embodiments, the circulation information of a token includes a circulation count or a circulation frequency, which is compared with a threshold value. The output constraint is met if the circulation count or circulation frequency is at or below the threshold value. For example, suppose that the output unit combination determined is a₂×β+a₃×γ, which means that the output unit combination includes two tokens with the identifiers of identify-β-a₂ and identify-γ-a₃, respectively. The circulation frequencies of the tokens are looked up in the database using the identifiers identify-β-a₂ and identify-γ-a₃. Suppose that in a table similar to Table 3, the circulation frequencies are found to be 1 time in a day and 3 times in a day, respectively. If the circulation frequency threshold is 5 times per day, then the two circulation frequencies are both below the threshold. Thus, the output unit combination meets this output constraint, and the process is allowed to proceed (e.g., a next output constraint, if available, is checked; when all the output constraints are met, the user accounts are updated, etc.). If the circulation frequency of any of the tokens in the output unit combination fails to meet the constraint, the process fails and the transaction is denied. The check on the circulation information prevents certain illegitimate transactions. In practice, it is found that hackers sometimes will transfer funds between different accounts many times in rapid succession to make it difficult to track the funds. Using tokens with identifiers in transactions and limiting the number of times a token can be circulated or the frequency a token can be circulated during a period of time help prevent the multiple-transfer hacking scheme. Account security is thus improved.

In some embodiments, an output constraint requires the target output account to be a trusted account. As used herein, the target output account refers to the account to which the output unit combination is sent. For example, if user A is to pay user B, then user B's account is the target output account. An account is deemed to be a trusted account if it has at least one token with an identifier that has stayed in the account (that is, has not been transferred) for some required amount of time. This is because many illegitimate accounts are set up as temporary accounts and are unlikely to store valuable assets for long periods of time. Thus, an account that stores certain tokens for the required amount of time tends to be legitimate. The determination can be made by logging the time each token is received in a user's account, looking up in the user's account status information database, and comparing the time at which each token in the user's account is received with the system's current time to determine how long the token has been stored in the account. In some embodiments, the output constraint further requires that the token that has stayed in the account has a value that meets or exceeds a minimum threshold (e.g., a target user has to store at least 100 Yuan's worth of tokens for more than a week).

In some embodiments, an output constraint requires the target output account to be an accredited account. As used herein, an accredited account refers to an account to which a specific sender account has made at least a certain number of successful transfers. It is presumed that transactions with accredited accounts are unlikely to be illegitimate, thus if the output constraint is met, the transaction can proceed without additional security checks, thus reducing the amount of computation required for such transactions and improving overall system efficiency.

In some embodiments, an output constraint requires the tokens in the output unit combination to be associated with one or more specified small token units (e.g., 1 cent, 5 cents, etc.) only. In some embodiments, tokens associated with small token units are not assigned a token identifier. Thus, equivalently, the output constraint is also met if the tokens in the output unit combination are found not to have any token identifiers. Transactions involving small token units only are permitted to proceed without further security checks to reduce the amount of computation required for such transactions and improve overall system efficiency.

In some embodiments, an output constraint requires the sum of token values of those tokens in the output unit combination that are associated with small token units and/or without token identifiers to be at or below a threshold. This constraint prevents situations where illegitimate transactions are conducted using small token units without unit identifiers (such as 1 million cents) to escape detection.

In some embodiments, an output constraint requires the total sum of token values of the output unit combination or the token value of each individual token in the output unit combination to be at or below a threshold. When the total amount or the individual token value that is transferred is small, circulation of the tokens is not limited.

The output constraints described above are for purposes of example and any other output constraints can be employed. In various embodiments, one or more output constraints are used. The selection and the ordering of the constraints depend on implementation. For example, in some embodiments, the process can proceed so long as one of the output constraints is met. Such implementation reduces the amount of computation required for security checks for each transaction and improves overall system efficiency. In some embodiments, the process can only proceed if certain combinations of the constraints are met, which provides greater security but requires greater computational resources, and can cause more legitimate transactions to be identified as illegitimate, which can be inconvenient for some users. For example, the trusted account output constraint is used in conjunction with the circulation limit constraint to make the transaction more secure. The selection of different combinations of output constraints can be flexibly made based on system requirements such as security level, computational resources, rate of false positives, etc.

Referring to 310, the user account is updated. In some embodiments, the tokens in the output unit combination are removed from the source user's account (user A's account) and added to the target user's account (in this case, user B's account), and the circulation count for each token involved in the transaction and has a corresponding token identifier is incremented, or the circulation frequency for each token involved in the transaction and has a corresponding token identifier is recomputed.

If, for example, the output unit combination has a total sum of token values that is equal to the requested amount (e.g., if a₂×β+a₃×γ is equal to m×β+n×γ), then those tokens are removed from the user A's account and added to user B's account. The circulation information associated with the tokens is updated by looking up the token identifier in the records, and if circulation information is available for a token, the corresponding circulation count is incremented or the corresponding circulation frequency is recomputed. In some embodiments, tokens corresponding to small token units may not have token identifiers and therefore, no circulation information needs to be updated.

If, however, the output unit combination has a total sum of token values that is greater than the requested amount, a token exchange process is performed to “make change.” For instance, suppose the output unit combination includes tokens a₂×β (token ID=identify-β-a₂) and a₃×γ (token ID=identify-γ-a₃), and the value of a₂×β+a₃×γ is greater than m×β+n×γ. The tokens in the output unit combination are removed from A's account, and one or more additional tokens (which can be newly issued tokens by the service platform) whose sum of token values corresponds to (a₂×β+a₃×γ)−(m×β+n×γ) are added to user A's account.

If the total value of tokens in user B's account is greater than or equal to (a₂×β+a₃×γ)−(m×β+n×γ), then tokens a₂×β and a₃×γ are added to user B's account, and the token exchange process is performed on the user B's account. Specifically, existing tokens in user B's account are examined to determine whether an output unit combination with a value of (a₂×β+a₃×γ)−(m×(3+n×γ) can be formed. If yes, tokens in this output unit combination are sent from user B's account to the user A's account (e.g., removed from user B's account and added to user A's account), and their circulation information is updated accordingly. If, however, such a combination cannot be formed, one or more tokens in the user B's account is further divided to generate a set of one or more tokens whose sum corresponds to (a₂×β+a₃×γ)−(m×β+n×γ), and this set of tokens is removed from the user B's account and added to user A's account. The circulation count of each token involved in the transaction is incremented or the circulation frequency is recomputed.

If, however, the total value of tokens in user B's account is less than (a₂×β+a₃×γ)−(m×β+n×γ) (in other words, user B cannot make change if tokens with values of a₂×β and a₃×γ is are received), the service platform can directly issue one or more tokens in the exact amount of (m×β+n×γ) to be added to user B's account. Identifiers associated with the newly issued tokens can be generated using the digital signal generation process described above. The service platform will also remove tokens in the amount of (m×β+n×γ) from user A's account. This can be done by removing tokens a₂×β and a₃×γ from A's account but issuing and adding new tokens with a total value of (a₂×β+a₃×γ)−(m×β+n×γ) to user A's account. Circulation information of tokens involved in the transaction is updated as appropriate.

The determination of the output unit combination and the update of user accounts are illustrated using the following example. Assume that Tables 1 and 2 correspond to user accounts for users A and B, respectively. Suppose that user A needs to pay user B 3.60 Yuan.

In this case, the amount that is requested is expressed as m×α+n×β=3x1+6x0.1. User A's account does not have “exact change,” but the token with a token ID of identify-α-a₁ and a token value of a₁×α=100x1 is greater than the requested amount. Thus, the output unit combination includes this token. If the set of one or more output constraints are met (e.g., the circulation count or frequency associated with must be less than 5), this token is removed from user A's account, its circulation number is incremented, and two new tokens of token value=96x1 and ID=identify-α-a₄, and token value=4x0.1 and ID=identify-β-a₅ are added to user A's account in exchange.

In this case, the token having a token ID of identify-α-a₁ and a token value of a₁×α=100x1 has been circulated once when it was issued to user A (thus has a circulation frequency of 1 at this point) which meets the output constraint that the circulation frequency be 5 times a day or less. Thus, this token is removed from user A's account and added to user B's account. Note that when this token is added to user B's account, its token ID (identify-α-a₁) remains the same. If the token is used again later (e.g., transferred from user B's account to user C's account), the token ID still remains the same. Each time the token is transferred, the circulation information corresponding to the token ID is updated. From B's account, the token with the token identifier of identify-α-b₁ is removed and new tokens with the token identifier identify-α-b₄ and corresponding token value of 103x1, and token identifier identify-β-b₅ and corresponding token value of 6x0.1 are issued and added to B's account during the token exchange process. The circulation information for these tokens is updated as well.

A's account after the update is shown as follows:

TABLE 5
User A's account

| Token ID | Token value |
|---|---|
| identify-β-a₂ | a₂ × β = 9 × 0.1 |
| identify-γ-a₃ | a₃ × γ = 4 × 0.01 |
| identify-α-a₄ | a₄ × α = 96 × 1 |
| identify-β-a₅ | a₅ × β = 4 × 0.1 |

B's account after the update is shown as follows:

TABLE 6
User B's account

| Token ID | Token value |
|---|---|
| identify-β-b₂ | b₂ × β = 3 × 0.1 |
| identify-γ-b₃ | b₃ × γ = 5 × 0.01 |
| Identify-α-a₁ | a₁ × α = 100 × 1 |
| Identify-α-b₄ | b₄ × α = 103 × 1 |
| Identify-β-b₅ | b₅ × β = 6 × 0.1 |

The circulation record is updated as follows:

TABLE 7

| Token ID | Number of times circulated |
|---|---|
| identify-α-a₁ | 2 |
| identify-β-a₂ | 1 |
| identify-γ-a₃ | 1 |
| identify-α-b₁ | 2 |
| identify-β-b₂ | 1 |
| identify-γ-b₃ | 1 |
| Identify-α-b₄ | 1 |
| Identify-β-b₅ | 1 |

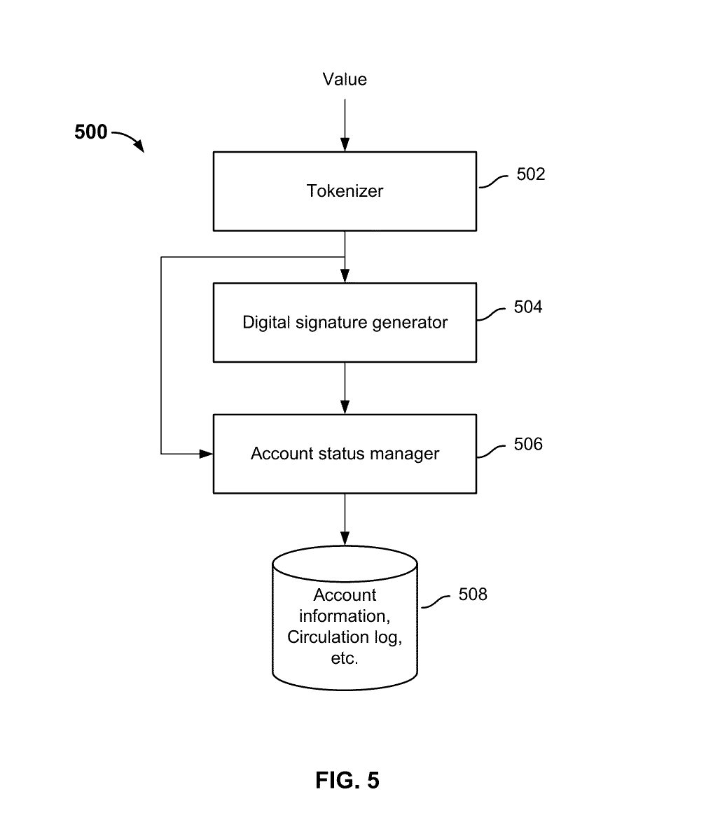

FIG. 5 is a block diagram illustrating an embodiment of a system configured to manage user accounts using tokens and token identifiers. System 500 can be used to implement at least a part of service platform 202.

In this example, system 500 includes a tokenizer 502, a digital signature generator 504, and an account manager 506. Tokenizer 502 is configured to receive a value and divide the value into one or more tokens according to tokenization rules as described above in connection with 402 of process 400. The token information is output to digital signature generator 504, which is configured to generate one or more corresponding digital signatures as identifiers for the one or more tokens, using functions such as cryptographic hash as described above in connection with 404 of process 400. The token information and corresponding identifiers are sent to account manager 506, which is configured to update account status information and initialize circulation information as described above in connection with 406-408 of process 400. The account status information and circulation information is stored in one or more databases 508.

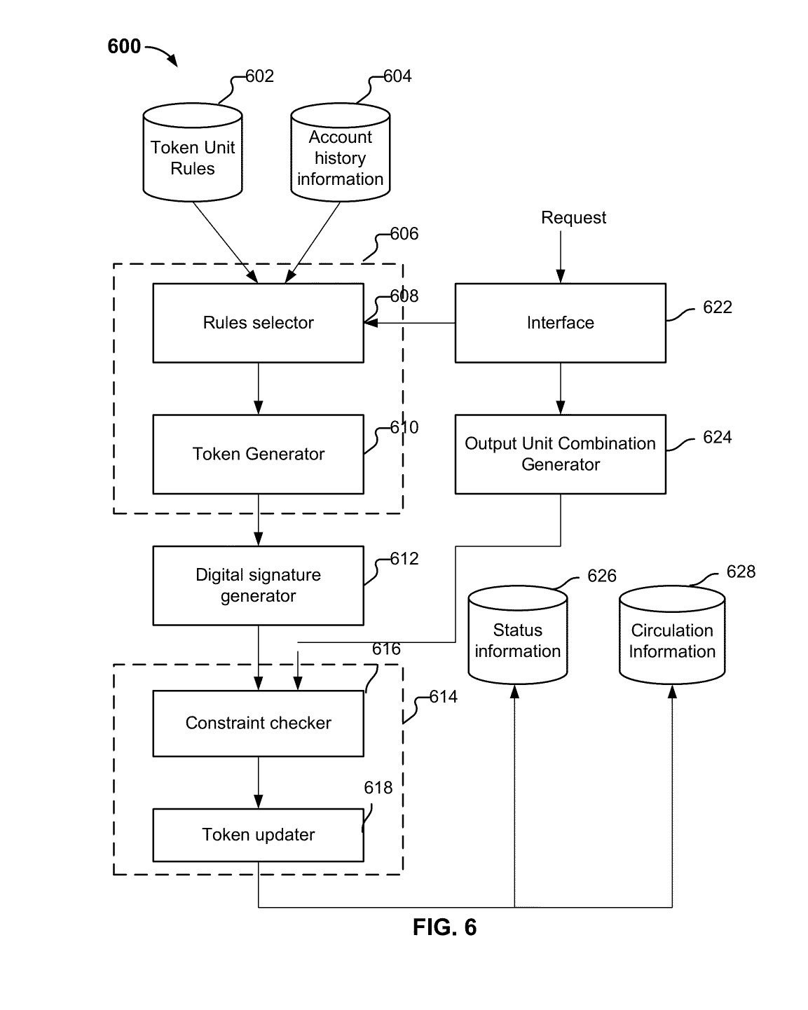

FIG. 6 is a block diagram illustrating another embodiment of a system configured to manage user accounts using tokens and token identifiers. System 600 can be used to implement at least a part of service platform 202.

In this example, system 600 includes an interface 622 configured to receive an account update request. The interface can be implemented to include external hardware connections, such as a port, cable, wireline or wireless network interface card, etc., and internal hardware connections such as a communication bus, a software interface such as application programming interfaces (APIs) provided by the service platform to programmatically exchange data such as the amount of value to be transferred, or a combination thereof. For example, a user can make a request to charge his own account or make a transfer to a different account by using a browser or application to invoke an API which accesses the account and sends the request information via interface 622.

Information pertaining to the received request such as the amount to be transferred, the source and target account information, etc. is sent to an output unit combination generator 624, which is configured to generate the output unit combination according to 306 of process 300 as described above. The output unit combination that is generated is sent to an account status manager 614. As shown, account status manager 614 includes a constraint checker 616 configured to check the output unit combination against a set of one or more constraints according to 308 of process 300 as described above. If the output unit combination meets a set of constraints, the output unit combination is sent to a token updater 618 which is configured to remove tokens in the output unit combination from the source account, perform token exchange if needed, add tokens to the target account, and update status information and circulation information in databases 626 and 628 according to 310 of process 300 as described above.

Further, system 600 includes a token unit rules database 602 and an account history information database 604, coupled to a tokenizer 606. Upon receiving a request to initialize an account, tokenizer 606 is invoked. Tokenizer 606 is similar to tokenizer 502 of 500 and includes a rules selector 608 configured to select a set of rules and a token generator 610 configured to generate the tokens based on the selected rules, according to 402 of process 400 as described above. Digital signature generator 612 is similar to digital signature generator 504 of 500 and is configured to generate digital signatures for the tokens according to 404 of process 400 as described above. The token information and corresponding identifiers are sent to account manager 614.

The components described above can be implemented as software components executing on one or more processors, as hardware such as programmable logic devices and/or Application Specific Integrated Circuits designed to perform certain functions or a combination thereof. In some embodiments, the components can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present application. The components may be implemented on a single device or distributed across multiple devices. The functions of the components may be merged into one another or further split into multiple sub-components. In some embodiments, the components operate continuously to process incoming requests.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
accessing a user account having a stored value, wherein the stored value is tokenized into a plurality of tokens corresponding to a set of available token units, and at least one of the plurality of tokens has a corresponding identifier; and
in response to an account output request that includes a requested amount to be output:
determining an output unit combination comprising a set of one or more tokens that has a sum that meets or exceeds the requested amount;
determining whether a set of one or more output constraints is met; and
in response to the determination that the set of one or more output constraints is met:
outputting the set of one or more tokens associated with the output unit combination; and
updating status information associated with the user account.

2. The method of claim 1, wherein the identifier includes a digital signature.

3. The method of claim 1, wherein the identifier is generated using a cryptographic hash function.

4. The method of claim 1, wherein outputting the set of one or more tokens associated with the output unit combination includes removing the set of one or more tokens from the user account.

5. The method of claim 1, wherein the user account is a source user account; and outputting the set of one or more tokens associated with the output unit combination includes adding the set of one or more tokens to a target user account.

6. The method of claim 1, wherein updating the user account further includes updating circulation information associated with a token in the set of one or more tokens in the output unit combination.

7. The method of claim 6, wherein updating the circulation information associated with the token includes looking up the circulation information using an identifier associated with the token.

8. The method of claim 6, wherein:
the circulation information includes a circulation count or a circulation frequency; and
updating the circulation information associated with the token includes incrementing the circulation count or recomputing the circulation frequency.

9. The method of claim 1, wherein the set of one or more output constraints includes at least one of the following:
a constraint requiring circulation information associated with at least some of the set of one or more tokens to at least meet a threshold;
a constraint requiring a target account to which the requested amount is sent to be a trusted account;
a constraint requiring a target account to which the requested amount is sent to be an accredited account to which at least a specified number of successful transfers are made;
a constraint requiring the set of one or more tokens in the output unit combination to be associated with one or more specified token units; or
is a constraint requiring a token value sum of the set of one or more tokens in the output unit combination to be at or below a threshold.

10. The method of claim 1, wherein the plurality of tokens is determined according to a set of one or more tokenization rules.

11. The method of claim 10, wherein the set of one or more tokenization rules includes a rule that specifies the set of available token units based on account history information.

12. A system, comprising:
one or more computer processors configured to:
access a user account having a stored value, wherein the stored value is tokenized into a plurality of tokens corresponding to a set of available token units, and at least one of the plurality of tokens has a corresponding identifier; and
in response to an account output request that includes a requested amount to be output:
determine an output unit combination comprising a set of one or more tokens that has a sum that meets or exceeds the requested amount;
determine whether a set of one or more output constraints is met; and
in response to the determination that the set of one or more output constraints is met:
output the set of one or more tokens associated with the output unit combination; and
update status information associated with the user account: and
one or more memories coupled to the one or more computer processors, configured to provide the one or more computer processors with instructions.

13. The system of claim 12, wherein the identifier includes a digital signature.

14. The system of claim 12, wherein the identifier is generated using a cryptographic hash function.

15. The system of claim 12, wherein to output the set of one or more tokens associated with the output unit combination includes to remove the set of one or more tokens from the user account.

16. The system of claim 12, wherein:
the user account is a source user account; and
to output the set of one or more tokens associated with the output unit combination includes to add the set of one or more tokens to a target user account.

17. The system of claim 12, wherein to update the user account includes to update circulation information associated with a token in the set of one or more tokens in the output unit combination.

18. The system of claim 17, wherein to update the circulation information associated with the token includes to look up the circulation information using an identifier associated with the token.

19. The system of claim 17, wherein:
the circulation information includes a circulation count or a circulation frequency; and
to update the circulation information associated with the token includes to increment the circulation count or to recompute the circulation frequency.

20. The system of claim 12, wherein the set of one or more output constraints includes at least one of the following:
a constraint requiring circulation information associated with at least some of the set of one or more tokens to at least meet a threshold;
a constraint requiring a target account to which the requested amount is sent to be a trusted account;
a constraint requiring a target account to which the requested amount is sent to be an accredited account to which at least a specified number of successful transfers are made;
a constraint requiring the set of one or more tokens in the output unit combination to be associated with one or more specified token units; or
a constraint requiring a token value sum of the set of one or more tokens in the output unit combination to be at or below a threshold.

21. The system of claim 12, wherein the plurality of tokens is determined according to a set of one or more tokenization rules.

22. The system of claim 21, wherein the set of one or more tokenization rules includes a rule that specifies the set of available token units based on account history information.

23. A computer program product embodied in a tangible non-transitory computer readable storage medium and comprising computer instructions for:
accessing a user account having a stored value, wherein the stored value is tokenized into a plurality of tokens corresponding to a set of available token units, and at least one of the plurality of tokens has a corresponding identifier; and
in response to an account output request that includes a requested amount to be output:
determining an output unit combination comprising a set of one or more tokens that has a sum that meets or exceeds the requested amount;
determining whether a set of one or more output constraints is met; and
in response to the determination that the set of one or more output constraints is met:
outputting the set of one or more tokens associated with the output unit combination; and
updating status information associated with the user account.
